(19) United States
(12) Patent Application Publication
(10) Pub. No.: US 2024/0126797 A1
(43) Pub. Date: Apr. 18, 2024

(54) METHODS AND SYSTEMS FOR RANKING TRADEMARK SEARCH RESULTS

(71) Applicant: Camelot UK Bidco Limited, London (GB)

(72) Inventors: Jan Waerniers, Aalter (BE); Ann Smet, Stekene (BE); Peter Keyngnaert, Deinze (BE)

(21) Appl. No.: 18/047,047

(22) Filed: Oct. 17, 2022

(51) Int. Cl. G06F 16/33; G06F 16/31

(52) U.S. Cl. CPC G06F 16/334; G06F 16/313

(57) ABSTRACT

A system is disclosed for ranking trademark search results. The ranking may be performed using one or more similarity models that comprises a trained model (e.g., a machine-learning model, an artificial intelligence model, or a deep neural network). In an example system, a candidate trademark name is received. A set of search results is obtained for the candidate trademark that identifies trademark names having at least a minimum degree of similarity with the candidate trademark name. The candidate trademark name and the set of search results are provided to a first trained model that outputs, for each trademark name, a trademark name similarity score. For each trademark name, a goods/services similarity score is obtained indicating a level of goods/services similarity with the candidate trademark name. A ranked list of results is provided based at least on a combination of the trademark name similarity scores and the goods/services similarity scores.

### BACKGROUND

Prior to applying for a new trademark, a search is often conducted to determine whether any similar trademarks exist. Such a search typically includes querying one or more databases to locate relevant results, which can be voluminous in many instances. Those results are then analyzed by an individual, such as a trademark expert, to identify trademarks that are sufficiently similar to the new trademark. However, given the amount of human resources required to manually review each search result, these techniques can be time consuming. In addition, different trademark experts may not carry out the same analysis or some results may be inadvertently overlooked, which can lead to inconsistencies and/or inaccuracies in reviewing searches.

In some existing solutions, hand-crafted rules are defined that enable relevant trademark results to be ranked. However, generation of these hand-crafted rules can similarly be time-consuming, and are often inflexible in their application. Another approach relies on analyzing administrative or judicial proceedings to attempt to learn how trademark name similarities are understood, but these techniques rely on a limited set of data, and do not take into account many other dimensions useful for conducting a thorough similarity analysis.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are disclosed herein for ranking trademark search results. In an example implementation, information about a candidate trademark is received, where the information includes a candidate trademark name and goods/services information associated with the candidate trademark. A set of search results is obtained for the candidate trademark that identifies trademark names having at least a minimum degree of similarity with the candidate trademark name. The candidate trademark name and the set of search results are provided to a first trained model, where the first trained model outputs, for each trademark name in the set of search results, a trademark name similarity score between the trademark name and the candidate trademark name. For each trademark name in the set of search results, a goods/services similarity score is obtained indicating a level of similarity between goods/services information associated with the trademark name and goods/services information associated with the candidate trademark name. A set of combined scores is generated based at least on the trademark name similarity scores and the goods/services similarity scores, and a ranked list of search results is provided (e.g., to a user interface) based at least on the set of combined scores.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for ranking trademark search results in accordance with an embodiment.

FIG. 2 shows a block diagram of an example system for ranking trademark search results in accordance with another embodiment.

FIG. 3 shows a flowchart for ranking trademark search results in accordance with an example embodiment.

FIG. 4 shows a flowchart for providing fragments of a candidate trademark name to a trained model in accordance with a further example embodiment.

FIG. 5 shows a flowchart for weighting terms of a fragment of a candidate trademark name in accordance with an example embodiment.

FIG. 6 shows a flowchart for ranking trademark search results based at least in part of a semantic similarity model in accordance with an example embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

As used herein, the term “trademark” is intended to encompass any symbol, logo, image, word, or words legally registered, established by use, or asserted as representing a company, product or service. The word “trademark” also encompasses service marks.

As used herein, the term “goods/services” is to be interpreted as equivalent to the term “goods and/or services.”

The example embodiments described herein are provided for illustrative purposes and are not limiting. The examples described herein may be adapted to any type of method or system for obtaining evidence of online commercial use of trademark. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section may be combined with any other embodiments described in the same section and/or a different section.

### II. Example Embodiments

by Prior to applying for a new trademark, a search is often conducted to determine whether any similar trademarks exist. Such a search typically includes querying one or more databases to locate relevant results, which can be voluminous in many instances. Those results are then analyzed an individual, such as a trademark expert, to identify trademarks that are sufficiently similar to the new trademark. However, given the amount of human resources required to manually review each search result, these techniques can be time consuming. In addition, different trademark experts may not carry out the same analysis or some results may be inadvertently overlooked, which can lead to inconsistencies and/or inaccuracies in reviewing searches.

In some existing solutions, hand-crafted rules are defined that enable relevant trademark results to be ranked. However, generation of these hand-crafted rules can similarly be time-consuming, and are often inflexible in their application. Another approach relies on analyzing administrative or judicial proceedings to attempt to learn how trademark name similarities are understood, but these techniques rely on a limited set of data, and do not take into account many other dimensions useful for conducting a thorough similarity analysis.

Embodiments described herein are directed to ranking trademark search results. For example, information about a candidate trademark is received, where the information includes a candidate trademark name and goods/services information associated with the candidate trademark. A set of search results is obtained for the candidate trademark that identifies trademark names having at least a minimum degree of similarity with the candidate trademark name. The candidate trademark name and the set of search results are provided to a first trained model, where the first trained model outputs, for each trademark name in the set of search results, a trademark name similarity score between the trademark name and the candidate trademark name. For each trademark name in the set of search results, a goods/services similarity score is obtained indicating a level of similarity between goods/services information associated with the trademark name and goods/services information associated with the candidate trademark name. A set of combined scores is generated based at least on the trademark name similarity scores and the goods/services similarity scores, and a ranked list of search results is provided (e.g., to a user interface) based at least on the set of combined scores.

The techniques described herein provide numerous benefits and advantages, including but not limited to a reduction in the utilization of computing resources (e.g., processing resources, memory resources, and network resources). For instance, by providing a system in which a trained model generates ranking scores that can be used, at least in part, to rank the results of a trademark search, manual review of the trademark search can be avoided. Such manual searches can require access to computing systems on which those results are provided, retrieval of data (e.g., over a network) relating to each individual trademark name in the search results and/or storage thereof on a computing device, and/or storage of user annotations associated with each reviewed search result. These activities, which utilize various computing resources, can thereby be minimized and/or avoided in accordance with the disclosed techniques relating to ranking of search results. Still further, utilization of one or trained models (e.g., neural networks trained specifically for scoring trademark search results) can improve the speed, accuracy and/or consistency of identifying similar trademarks.

Furthermore, by providing a ranked set of search results, such as a subset of the entire set of search results, to a receiving computing device, the amount of data transferred over a network to the computing device and/or stored on the receiving computing can also be reduced. Accordingly, various benefits and/or advantages can be achieved in accordance with the disclosed embodiments.

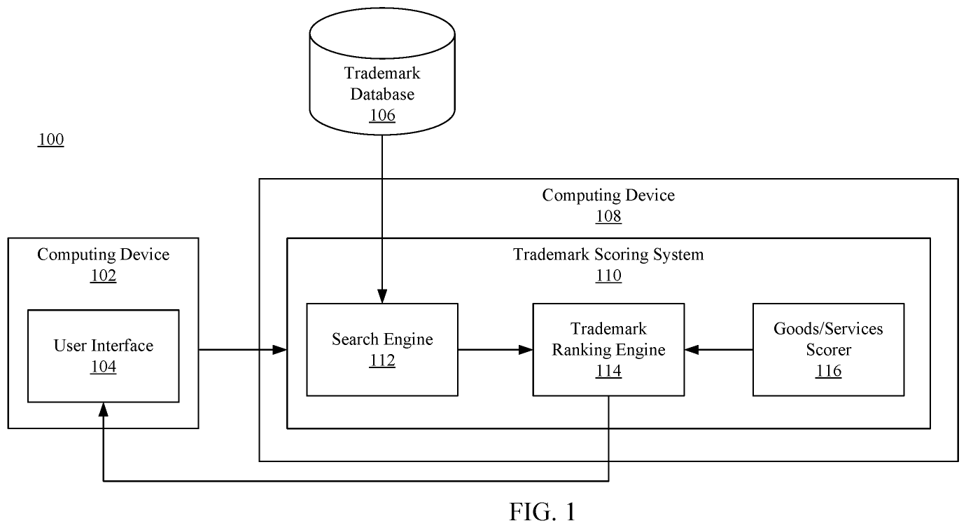

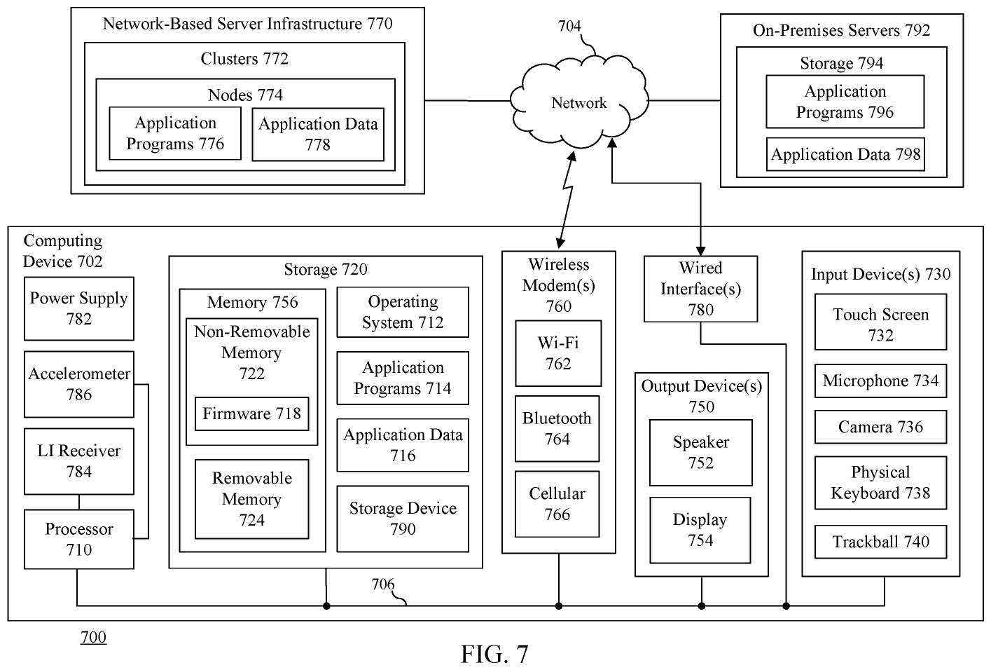

Embodiments may be implemented in various ways. For instance, FIG. 1 shows a block diagram of a system 100 for ranking trademark search results, according to an example embodiment. As shown in FIG. 1, system 100 includes a computing device 102, a trademark database 106, and a computing device 108. Computing device 102 includes a user interface (UI) 104. Computing device 108 includes a trademark scoring system 110. As shown in FIG. 1, trademark scoring system 110 includes a search engine 112, a trademark ranking engine 114, and a goods/services scorer 116. In embodiments, computing device 102, trademark database 106, and/or computing device 108 are communicatively coupled via a network that comprises one or more of a local area network (LAN), a wide area network (WAN), an enterprise network, the Internet, etc., and includes one or more of wired and/or wireless portions. Computing device 102 may be any type of processing device, including, but not limited to, a desktop computer, a server, a mobile or handheld device (e.g., a tablet, a personal data assistant (PDA), a smart phone, a laptop, etc.), an Internet-of-Things (IoT) device, or other suitable device mentioned elsewhere herein or otherwise known. Computing device 108 comprises one or more server computers and/or other types of computing devices, which may include one or more distributed or “cloud-based” servers (such as further described elsewhere herein) in embodiments. Trademark database 106 may be implemented on any suitable computing device (including but not limited to one or more server computers). In examples, computing device 102, trademark database 106, and/or computing device 108 (and/or any components therein) may be implemented by the computing device shown in FIG. 7.

UI 104 comprises a user interface for initiating a trademark search and/or a ranking of trademark search results, as described herein. In examples, UI 104 may comprise any one or more UI elements, user input-fields, menus, etc. that enable a user to input information relating to a candidate trademark, such as a candidate trademark name and/or goods/services information associated with the candidate trademark. In further examples, UI 104 may comprise one or more UI elements for presenting a ranked listing of trademark search results received from trademark scoring system 110. Such UI elements may also enable a user to interact with (e.g., organize, sort, etc.) information in the ranking, view additional information associated with each trademark name in the search results, or any other information as appreciated by those skilled in the relevant art.

In examples, a candidate trademark comprises information relating to a trademark, such as but not limited to an unregistered trademark. For instance, the candidate trademark may comprise a trademark name that is sought to be searched against other trademarks (e.g., other registered or unregistered trademarks). In some implementations, the candidate trademark may also include information associated with a proposed goods/services class (or classes) in which trademark protection of the candidate trademark is desired. The goods/services class may identify, among other things, a class number or category, a description of goods and/or services in which the trademark may be in use, or other fields of uses of the candidate trademark name. In other examples, a candidate trademark comprises information relating to a registered trademark or a trademark that is currently in use. For instance, UI 104 may receive an input comprising a trademark name for purposes of searching for, and ranking, other trademarks that may also be in use that are similar to the inputted trademark name. As used herein, a trademark includes service marks and other similar types of marks as appreciated by those skilled in the relevant art. While example embodiments are described herein in which UI 104 may receive candidate trademark information, UI 104 (and components of trademark scoring system 110) may be used to search for, and rank, other types of information (e.g., text-based information) as an alternative to trademark-related information.

Trademark database 106 is configured to store information associated with existing trademarks, such as trademarks that are registered, trademarks that were previously registered, trademarks that have been applied for, or other trademarks that are in use (e.g., common-law trademarks). In some implementations, trademark database 106 may comprise various company names, product lines, product names, product models, services, etc. that may have been in use in the past, are currently in use, and/or may be in use in the future. For each trademark stored therein, trademark database 106 may store the trademark name (e.g., a string of characters that comprise the trademark), an identification of goods/services information associated with the trademark (e.g., one or more goods/services classes), information identifying the trademark owner or applicant, a date of the trademark application and/or registration, a status of trademark application and/or registration, and/or any other information associated with a trademark. Trademark database 106 may store such information in any suitable fashion, including but not limited to a listing, a table, etc., across any number of files. Further, although trademark database 106 is illustrated as a database, trademark database 106 is not limited to a database and instead may comprise other suitable forms in which information is stored and/or accessed (e.g., as structured and/or unstructured data).

While a single trademark database is illustrated in FIG. 1, implementations may include any number of trademark databases (e.g., different repositories that may store different types of trademark information). For instance, a first database may store information relating to trademarks in a first region (e.g., country), a second database may store information relating to trademarks in a second region, and so on. In some examples, trademark database 106 may be coupled to and/or be populated with information from one or more governmental organizations in which trademark applications may be submitted, reviewed, and/or granted for registration. In yet another example, trademark database 106 may be coupled to one or more other data sources (e.g., the Internet) in which information associated with trademarks may be retrieved.

Search engine 112 may be configured to receive (e.g., from UI 104) a candidate trademark that may include a candidate trademark name, and perform a search of trademark database 106 to identify one or more trademarks (e.g., trademark names) that have a at least minimum degree (e.g., a threshold level) of similarity with the candidate trademark name. For instance, search engine 112 may identify trademark names from trademark database 106 that have a threshold level of similarity with the candidate trademark name based at least on one or more characters and/or words of the candidate trademark name and the trademark names stored in trademark database 106. In some other examples, search engine 112 may identify similar trademark names based at least on goods/services information associated with the candidate trademark name and/or the trademark names stored in trademark database 106. The minimum degree of similarity may comprise a measure of similarity that indicates at least a partial overlap between the candidate trademark name and one or more trademark names of trademark database 106, such as a common letters, a common sequence of letters, a common appearance, etc.

In various embodiments, search engine 112 may be configured to identify trademark names similar to the candidate trademark name based on a relatively low degree of similarity, such that a comprehensive set of search results are obtained. For example, the retrieved search results may be over-inclusive such that they contain a larger number of false-positive hits compared to true positive hits. Search engine 112 may be configured to utilize any suitable searching algorithm to search trademark database 106. In some implementations, search engine 112 may comprise a machine-learning engine or a neural network (e.g., a deep neural network) to identify a set of search results that identify trademark names similar to the candidate trademark name. In examples, search engine 112 may be configured to generate, upon performing the search of trademark database 106, an unranked (e.g., initial) set of search results. As described in further detail below, the results of search engine 112 may be ingested by trademark ranking engine 114, which may rank such search results according to the level of similarity between the candidate trademark and each trademark identified by the search engine.

Goods/services scorer 116 may be configured to generate a goods/services score that represents a level of similarity between goods/services information (e.g., a goods/services class) associated with the candidate trademark name and goods/services information (e.g., a goods/services class) associated with a trademark name in the set of search results. For instance, goods/services scorer 116 may take into account the similarity between the products and/or services associated with each trademark name in a pair of trademarks that are compared. Where at least partial overlaps exists between the goods/services information of a pair of trademarks, the goods/services score may comprise a value greater than zero. A relatively large overlap (e.g., identical goods/services classes) may be assigned a greater value, such as a value close to 1, where the range of the goods/services score is from 0 to 1. In implementations, goods/services scorer 116 may implement one or more models (e.g., machine-learning (ML) models, artificial intelligence (AI) models, deep neural network (DNN) models, etc.) trained based on a corpus of training data that includes goods/services information for registered trademarks, such as a description of the goods/services associated with the registered trademark and/or the class associated with the description of the goods/services. Based on application of such a model, goods/services scorer 116 may output a goods/services score for each pair of trademarks that indicates a level of similarity between the goods/services thereof. Additional details regarding the generation of a goods/services similarity score may be found in U.S. Pat. No. 10,565,533, filed on May 19, 2016, and entitled “Systems and Methods for Similarity and Context Measures for Trademark and Service Mark Analysis and Repository Searches,” the entirety of which is incorporated by reference

Trademark ranking engine 114 may be configured to obtain a set of search results from search engine 112 and rank such search results based at least on scores generated for each trademark name in the set of search results. In one example, trademark ranking engine 114 may comprise a model (e.g., an ML model, an AI model, a DNN model, etc.) for generating a similarity score between the candidate trademark name and each trademark name in the set of search results. The model may be trained in various ways, such as by using pairs of historical trademark names marked as either similar or dissimilar to each other (e.g., by a user). In some examples, a plurality of models are implemented in trademark ranking engine 114, each model being configured to generate a similarity score between the candidate trademark name and each trademark name in the set of search results. In various embodiments, trademark ranking engine 114 may comprise one or more models configured to generate similarity scores based on auditive and/or visual similarities between a pair of trademarks (e.g., the candidate trademark name and a trademark name in the set of search results) and/or one or more semantic similarity models configured to generate a similarity score based on a semantic similarity between a pair of trademarks.

In example embodiments, trademark ranking engine 114 may also be configured to ingest a goods/services score from goods/services scorer 116 for each pair of trademarks that are compared. Trademark ranking engine 114 may combine the similarity score generated based on application of the pair of trademarks to a model (or a plurality of similarity scores where multiple models are implemented) and the goods/services score for the pair of trademarks to generate a combined score for the pair of trademarks. Upon generating a combined score in such a manner for each such pair of trademarks, trademark ranking engine 114 may rank the search results according to the combined scores and provide the ranked list of the search results to UI 104. In this manner, trademark ranking engine 114 may generate and/or provide a ranked list of search results that takes various dimensions into account. Additional details regarding the operation of trademark ranking engine 114 will be described below.

Implementations are not limited to the illustrative arrangement shown in FIG. 1. For instance, computing device 102, trademark database 106, and/or computing device 108 need not be separate or located remote from each other. In some examples, any one or more of computing device 102, trademark database 106, and/or computing device 108 (or any subcomponents therein) may be located in or accessible via the same computing device or distributed across a plurality of devices. For instance, techniques described herein may be implemented in a single computing device. Furthermore, system 100 may comprise any number of additional computing and/or storage device coupled in any manner in accordance with the disclosed embodiments.

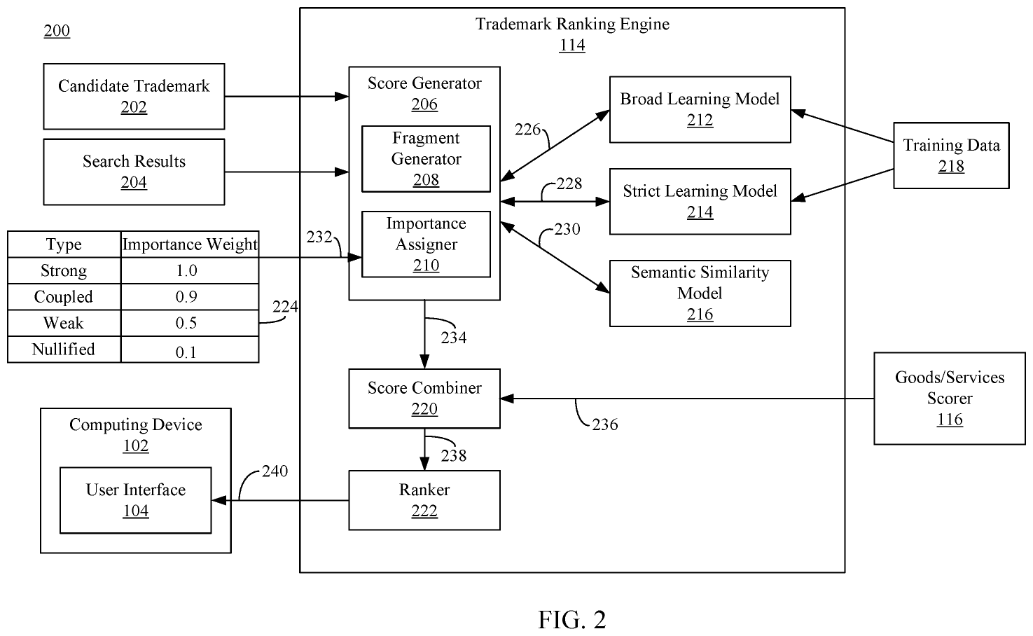

FIG. 2 depicts a block diagram of a system 200 for ranking trademark search results, in accordance with another embodiment. As shown in FIG. 2, system 200 includes an example implementation of computing device 102, an example implementation of trademark ranking engine 114, an example implementation of goods/services scorer 116, a candidate trademark 202, search results 204, training data 218, and an importance weight table 224. Computing device 102 comprises an example implementation of UI 104. As further shown in FIG. 2, trademark ranking engine 114 comprises a score generator 206, a broad learning model 212, a strict learning model 214, a semantic similarity model 216, a score combiner 220, and a ranker 222. In implementations, candidate trademark 202 may comprise a candidate trademark name and/or goods/services information associated with a candidate trademark inputted via UI 104. Search results 204 may comprise a set of trademark search results generated by search engine 112, as described herein.

To rank a set of trademark search results, candidate trademark 202 and search results 204 are provided to score generator 206. As discussed herein, candidate trademark 202 may be provided via UI 104, and includes information identifying a candidate trademark name (or service mark, or similar term(s) for which similar results are to be searched for various purposes) and/or goods/services information associated therewith. The candidate trademark name may comprise a character (e.g., a letters, number, and/or symbol), a set of characters, a phrase, a graphic containing text, etc. Goods/services information associated with the candidate trademark name may indicate a goods/services description (e.g., a phrase identifying products or product types for which the candidate trademark is associated), and/or a goods/services class or subclass number. In another example, goods/services information may also comprise an identification of countries or jurisdictions for the candidate trademark name (e.g., countries in which trademark protection is desired).

As discussed herein, search results 204 are generated by search engine 112 based at least on candidate trademark 202, such as by searching trademark database 106 for a subset of trademark names that have at least a minimum degree of similarity with the candidate trademark name. For instance, search results 204 may identify one or more trademark names in trademark database 106 that have one or more characters or words in common with the candidate trademark name. In examples, search results 204 may comprises hundreds or thousands (or more) of trademark names that have at least a minimum degree of similarity with the candidate trademark name. Search results may be generated by search engine 112 in various ways, including but not limited to, user-created rules or logic for searching and/or filtering results from trademark database 106.

Score generator 206 may be configured to generate one or more similarity scores between each trademark name in search results 204 and the candidate trademark name. For instance, score generator 206 may generate a score by applying a model (e.g., an ML model, an AI model, a DNN model, etc.) to a pair of trademarks (e.g., a trademark name of search results 204 and the candidate trademark name) for which a similarity score is to be generated. In example implementation, score generator 206 may apply any combination of one or more of broad learning model 212, strict learning model 214, and semantic similarity model 216. In some implementations, score generator 206 may apply each such model (and/or one or more additional models not shown herein) to generate a plurality of similarity scores for each pair of trademarks.

As shown in FIG. 2, broad learning model 212 and strict learning model 214 are trained using training data 218. Training data 218 may include one or more labels assigned to historical pairs of trademark names that were previously analyzed (e.g., based on search results generated for a previously inputted candidate trademark). For instance, the label may indicate whether the two trademark names in a pair of trademark were sufficiently similar or dissimilar to each other based at least on an analysts' review (e.g., similar in terms of a likelihood of confusion or other standard). In some implementations, the label may be binary (e.g., the pair of trademarks is labeled as either similar or dissimilar). In other implementations, training data 218 may indicate a further granularity between a level of similarity between a pair of trademarks, such as the pair being not similar, marginally similar, neutral, similar, strongly similar, and/or identical. This is only illustrative, however, and training data 218 may comprise any other label assigned to a pair of trademarks. In some further implementations, training data 218 may also comprise one or more user-inputted annotations for a pair of trademarks that may indicate additional information regarding the similarity determination, such as the reasons for pair being identified as similar or dissimilar. In implementations, the labels for each pair of trademarks may be stored in a suitable data structure (e.g., a database) on a storage device. The number of historical pairs for which labels are stored may be in the thousands (or more), and may be based on several years of analysts' selections.

In some implementations, training data 218 may comprise an imbalance of false positive cases (e.g., pairs of trademarks that are marked as not similar) and true positive cases (pairs of trademarks that are marked as similar). In such instances, a training algorithm may subsample cases from the full set of training data such that the ratio of false positive cases to true positive cases is reduced compared to the original data set. In one implementation, the training algorithm may subsample the training data used for training the learning models described herein by setting a ratio of 2:1 for false positive to true positive cases. In some implementations, the training algorithm may select all of the true positive cases from training data 218 and randomly select a subset of the false positive cases up to a desired ratio. By subsampling in this manner, true positive cases may be better represented in the training set. Further, the reduction in false positive cases may improve the speed at which the learning models are trained, while reducing the computing resources consumed during the training phase. Furthermore, such subsampling that better represents the true positive cases may also improve the overall quality of the model (e.g., the performance of the learning model).

Broad learning model 212 may comprise a learning model (e.g., an ML model, an AI model, a DNN model, etc.) that is trained using a first subset of training data 218. In an example, the first subset of training data may comprise historical selections for pairs of trademark names where the trademark name identified from a set of search results does not contain any additional words beyond the candidate trademark name for which the similarity determination is made (e.g., the number of words are deemed to be at least similar). Such additional words may comprise, for instance, one or more words that are not present in the candidate trademark name. In some implementations, the determination of whether a trademark name contains an additional word may be based on a total number of words present in the trademark name identified from a set of search results and the candidate trademark name. In other implementations, the determination of whether a trademark name contains an additional word may be based on identifying one or more words in the trademark name that are not present identically in the candidate trademark name. In another implementation, the determination may be based on identifying one or more words in the trademark name that are not phonetically similar to, visually similar to, and/or semantically similar to any words of the candidate trademark name. In yet another implementation, the determination of additional words may be performed as described above, except that the determination is based on additional words present in the candidate trademark name that are not in the trademark name identified from the search results.

By training broad learning model 212 in the manner as described, broad learning model 212 may be trained to generate a similarity score 226 for a pair of trademarks based on a different level of variation or similarity between characters and/or words of the trademark name identified in a set of search results and a candidate trademark name. For instance, by focusing the training of broad learning model 212 on a subset of training data 218 in which additional words are not present, the level of variation between trademark names in a pair of trademarks may be broader than compared to instances where additional words are present.

Strict learning model 214 may comprise a learning model (e.g., an ML model, an AI model, a DNN model, etc.) that is trained using a second subset of training data 218. In an example, the second subset of training data may comprise historical selections for pairs of trademark names where the trademark identified from a set of search results contains additional words beyond the candidate trademark name for which the similarity determination is made (e.g., the number of words are deemed to be at least dissimilar). For instance, where additional words are present, the level of similarity between the trademark names in a pair of trademarks is inferred as being relatively higher compared to instances where additional words are not present. In this manner, strict learning model 214 may be trained in such a manner that enables it to generate a similarity score 228 that more strictly compares the words of the trademark names (e.g., where additional words are present, a stronger similarity is inferred to be present between words of the trademark names).

By training broad learning model 212 and strict learning model 214 in this fashion using training data 218 (including subsets thereof), such learning models may be configured to learn characteristics of trademark name similarity based at least on prior analysts' selections on historical pairs of trademarks. In some implementations, such as where both broad learning model 212 and strict learning model 214 are used by score generator 206, one model may be weighted more heavily than the other. In some other examples, the models may be weighted equally when generating a score for a given pair of trademarks.

In examples, broad learning model 212 and/or strict learning model 214 may be configured to generate a similarity score based on a level of visual and/or auditive similarity of a pair of trademarks (or portions of such trademarks). In an example, a level of visual similarity indicates how similar two trademark names appear visually to each other. A level of auditive (or phonetic similarity) indicates how similar two trademark names sound to each other (e.g., when spoken). In various embodiments, because such models are trained based on prior user selections, these models may be configured to mimic user selections in terms of similarity when provided with new pairs of trademarks in a manner that accurately reflects a level of auditive and/or visual similarities of terms of the trademark name. In examples, such models described herein may comprise DNNs. For instance, where such models comprise DNN models, the model may be trained at the character level (e.g., a separate vector embedding for each individual uppercase and lowercase letter, each number, each symbol, etc.). In this manner, the model(s) may be configured to generate similarity scores based at least on character-level differences between characters in a pair of trademarks (e.g., an “m” character may have a relatively high phonetic (e.g., auditive) and visual similarity to an “n” character, while an “m” character may have a lower phonetic and visual similarity to an “s” character), based on information contained in training data 218. Further, the DNN may also comprise a bidirectional layer that also considers the context in which a character is present in a given trademark name (e.g., what position the letter is in within a larger term), resulting in a more accurate model for scoring visual and/or phonetic similarities. However, other models may also be implemented, such as ML models using a random forest techniques or other types of learning algorithms.

Semantic similarity model 216 may be configured to generate a similarity score 230 based on a semantic similarity between a pair of trademarks. In some implementations, semantic similarity model 216 may comprise a model that is trained in a plurality of different languages. In one example, where a trademark (either a trademark name identified from the search results or the candidate trademark name) comprises a coined term (e.g., a term or string or characters that is made up, or does not comprise a dictionary definition), semantic similarity model 216 may be weighted relatively low compared to broad learning model 212 and/or strict learning model 214, or not used at all in generation of a combined score. In such situations, greater weight may be assigned to the visual and/or phonetic similarity models (e.g., broad learning model 212 and/or strict learning model 214). In some other examples (such as where a trademark name is a slogan that contains a phrase comprising several dictionary words), semantic similarity model 216 may be assigned a higher weight than the visual and/or phonetic similarity models given that semantics may play a play a larger role in such instances in determining overall similarity.

Fragment generator 208 may be configured to generate fragments corresponding to trademark names in a pair of trademarks for providing to broad learning model 212 and/or strict learning model 214. In examples, fragments may comprise a subset of a trademark name (e.g., in a forward and/or reverse order), a subset of a trademark name that includes one or more characters that are replaced based on an auditive and/or visual similarity, a subset of a trademark name that replaces a term with a semantically similar term, etc. In some examples, the fragment may comprise any combination of the foregoing. Further details regarding the operation of fragment generator 208 will be described below.

Importance assigner 210 may be configured to assign, for any term of the candidate trademark name or a trademark name identified in search results 204 (including fragments thereof) an importance weight 232. The importance weight may indicate, for instance, relative measure of importance for a term based on goods/services information associated with the trademark, such as a frequency of the term in goods/services descriptions of one or more goods/services classes of a trademark corpus. Further details regarding the operation of importance assigner 210 will be described below.

Score combiner 220 is configured to combine (e.g., mathematically) similarity scores 234 generated by score generator 206 (e.g., using broad learning model 212, strict learning model 214, and/or semantic similarity model 216). In this manner, score combiner 220 may combine similarity scores based on a visual similarity, phonetic similarity, and/or a semantic similarity for a pair of trademarks.

In some examples, score combiner 220 may be configured to receive validation data from one or more subject matter experts (SMEs) that manually validated a subset of searches in training data 218. During the manual validation, inputs are received that may indicate a similarity level between each pair of trademarks for a plurality of pairs. The trademark level may indicate whether the similarity is high (e.g., critical), medium (e.g., relevant), noise (e.g., not relevant), or indifferent. Accordingly, based on such validation, each trademark from a trademark search for a candidate trademark is annotated with one of a plurality of levels. In implementations, such a validation process may be repeated for a plurality of trademark searches.

This validation information may provide additional data relating to a level of similarity, which may not be present in training data 218 (which may be based on binary labels) used to train the learning models. Based on the validation by the SMEs, score combiner 220 may be configured to combine the results (e.g., scores) generated by the various models (e.g., broad learning model 212, strict learning model 214, and/or semantic similarity model 216) in a certain manner (e.g., by fine tuning the combination logic) that not only accurately mimics human behavior, but also reflects a similarity level that may not be present in training data 218.

In a further implementation, score combiner 220 may combine (e.g., mathematically) one or more similarity scores generated by score generator 206 with a goods/services score 236 obtained from goods/services scorer 116. As noted above, a goods/services score may indicate a level of similarity between goods/services information associated with a candidate trademark and goods/services information associated with another trademark name identified in the search results. For instance, the goods/services description for a candidate trademark may indicate that the candidate trademark is related to “energy drinks,” while the goods/services description for a trademark name in the search results may indicate that the trademark is related to “fruit juices.” Such goods/services description may comprise a relatively high level of similarity (e.g., a medium similarity) with a particular associated weighting factor (e.g., 0.8). In another example, certain goods/services information between the candidate trademark name and the trademark name in the search results may be identical, resulting in a higher level of similarity and a higher associated weighting factor (e.g., 1.0). In some implementations, semantic similarity may also be taken into account in generating a goods/services score (e.g., goods/services descriptions that are semantically the same may still be considered identical). In examples, goods/services scorer 116 may be trained on various goods/services information (e.g., goods/services descriptions) based on any suitable training algorithm, such as unsupervised learning in accordance with a fastText learning algorithm for identifying semantic relationships between words present in the descriptions.

Ranker 222 may be configured to rank the set of search results 204 based at least on the combined scores 238 generated by score combiner 220 (e.g., from highest to lowest). For instance, trademark names in search results 204 that have a relatively high combined score with the candidate trademark name may be identified as having a strong similarity with the candidate trademark name. In one example, ranker 222 may attach a ranking value to each trademark name in search results 204 based on its combined score (e.g., the highest score has a ranking value of 1, the second highest score has a ranking value of 2, and so on). In some implementations, ranker 222 may generate a ranked list that comprises a subset of search results 204 (e.g., the top n number of trademark names in search results 204 based on their respective combined scores). Ranker may provide the ranked list 240 of search results to UI 104 such that the ranked list may be viewed and/or interacted with (e.g., sorting, filtering, etc.) by a user of UI 104.

The disclosed techniques may provide various advantages, in addition to those discussed previously. For instance, the models relied upon can be readily re-trained and/or fine-tuned over time based on additional training data to improve the accuracy of the generated rankings. In contrast to existing techniques that are typically static and/or based on hand-written rules, the disclosed techniques may improve over time by virtue of retraining the models with additional data. In addition, maintenance of such systems described herein may be performed in a more efficient and/or less expensive manner, as improving and/or updating the ranking system may be performed automatically based on training data that is available.

Furthermore, in some implementations, the models may be trained for a particular client (e.g., a customer), such as by relying on a subset of training data 218 associated with that client. By using the client's specific training data for training the models described herein, the models may be automatically tuned using transfer learning based on that client's specific selection behavior, thereby enabling a personalized or client-specific trademark ranking system that is flexible and adaptive based on the purposes for which it is needed.

Still further, the ranked list of search results provided to UI 104 may enable an efficient review of relevant search results by a user (e.g., review of irrelevant or non-similar trademarks can be minimized or even avoided). Such techniques may thereby save clients time in reviewing results and minimize a risk of missing or overlooking a result (e.g., which may happen in conventional techniques where all of the search results are reviewed by a user, or where hand-crafted rules are not accurate).

Implementations are not limited to the illustrative arrangement shown in FIG. 2. For instance, any of the components (or subcomponents therein) need not be separate or located remote from each other. In some examples, any one or more of the components (or any subcomponents therein) illustrated in FIG. 2 may be located in or accessible via the same computing device or distributed across a plurality of devices. Furthermore, system 200 may comprise any number of additional devices coupled in any manner in accordance with the disclosed embodiments.

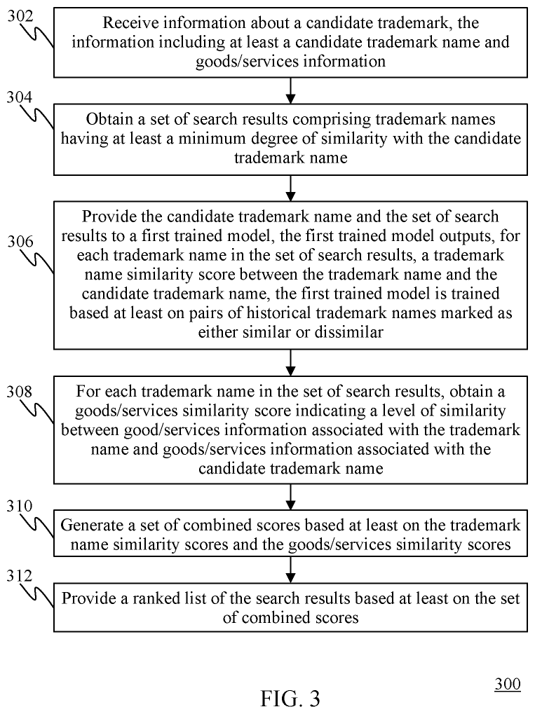

Accordingly, ranking a set of trademark search results is provided in various ways. For example, FIG. 3 shows a flowchart 300 for ranking trademark search results, according to an example embodiment. In an embodiment, flowchart 300 is implemented by system 100 as shown in FIG. 1 and/or system 200 as shown in FIG. 2. Accordingly, flowchart 300 will be described with reference to FIG. 1 and FIG. 2. Other structural and operational embodiments will be apparent to persons skilled in the relevant art(s) based on the following discussion regarding flowchart 300, system 100 of FIG. 1, and system 200 of FIG. 2.

Flowchart 300 begins with step 302. In step 302, information about a candidate trademark is received, where the information includes at least a candidate trademark name and goods/services information. For example, with reference to FIG. 2, UI 104 may receive information about a candidate trademark. The candidate trademark information may be provided to search engine 112 to generate a set of search results 204. The candidate trademark information may also be provided to score generator 206, as described herein. As discussed earlier, the candidate trademark information may identify any trademark (including service marks) for which a user seeks to compare to other trademarks that are in use, may be in use in the future, and/or have been in use in the past. In examples, the candidate trademark information may therefore comprise a trademark name for which registration may be sought, a trademark name for which a clearance is desired, or the like. While example embodiments are described relating to trademarks (including service marks), implementations described herein may also be applied in other contexts where word and/or phrase similarity are analyzed for various purposes.

In step 304, a set of search results is obtained comprising trademark names having at least a minimum degree of similarity with the candidate trademark name. For example, with reference to FIG. 1 and FIG. 2, score generator 206 may be configured to obtain a set of search results 204 generated by search engine 112. Search results 204 may comprise an identification of a subset of trademark names in trademark database 106 that have at least a minimum degree of similarity with the candidate trademark name. In examples, the minimum degree of similarity may comprise a minimum degree of visual similarity, auditive similarity, semantic similarity, or a similarity that may be based on user-defined rules or logic (e.g., fuzzy logic) governing the operation of search engine 112.

In step 306, the candidate trademark name and the set of search results are provided to a first trained model. In examples, the first trained model outputs, for each trademark name in the set of search results, a trademark name similarity score between the trademark name and the candidate trademark name. In a further implementation, the first trained model is trained based at least on pairs of historical trademark names marked as either similar or dissimilar. For example, with reference to FIG. 2, the candidate trademark name and the set of search results are provided to broad learning model 212 and/or strict learning model 214, each of which may output, for each trademark name in search results 204, a trademark name similarity score between the trademark name and the candidate trademark name. As discussed earlier, broad learning model 212 and/or strict learning model 214 may be trained based at least on training data 218, which may include pairs of historical trademarks names that were marked as similar (or dissimilar, or labeled/annotated in any other fashion).

In some implementations, a pair of trademarks (e.g., a trademark name in search results 204 and the candidate trademark name) may be provided to the trained model to obtain a trademark name similarity score for the pair. In another implementation, a batch of pairs (which may be all of the pairs between trademark names in search results 204 and the candidate trademark name, or a subset thereof) may be provided to obtain a trademark name similarity score for each pair in the batch, such as to improve the speed at which scores are generated. In some further implementations, as will be described below, a fragment of a trademark name of search results 204 and/or a fragment of the candidate trademark name may be provided to each such learning model to generate a trademark name similarity score based on the pair of fragments.

In step 308, for each trademark name in the set of search results, a goods/services similarity score is obtained indicating a level of similarity between goods/services information associated with the trademark name and goods/services information associated with the candidate trademark name. For example, with reference to FIG. 2, score combiner 220 may be configured to obtain a goods/services similarity score from goods/services scorer 116 that indicates a level of similarity between goods/services information associated with a trademark name of search results 204 and the goods/services information associated with the candidate trademark name.

In step 310, a set of combined scores is generated based at least on the trademark name similarity scores and the goods/services similarity scores. For example, with reference to FIG. 2, score combiner 220 may be configured to obtain one or more trademark name similarity scores for each pair of trademarks that are compared (e.g., a trademark name of search results 204 and the candidate trademark name), and combine the one or more trademark name similarity scores with the goods/services similarity score for the pair of trademarks. In examples, score combiner 220 may weight each of the scores equally or may weight one or more of the scores higher or lower than another score to generate the combined score for the pair of trademarks. For instance, in some examples, the trademark name similarity scores may have a greater weight than the goods/services score when combining the scores together.

In step 312, a ranked list of the search results is provided based at least on the set of combined scores. For example, with reference to FIG. 2, ranker 222 may generate a ranked list of search results based on the combined scores for each pair of trademarks, and provide the ranked list (or a portion thereof) to UI 104.

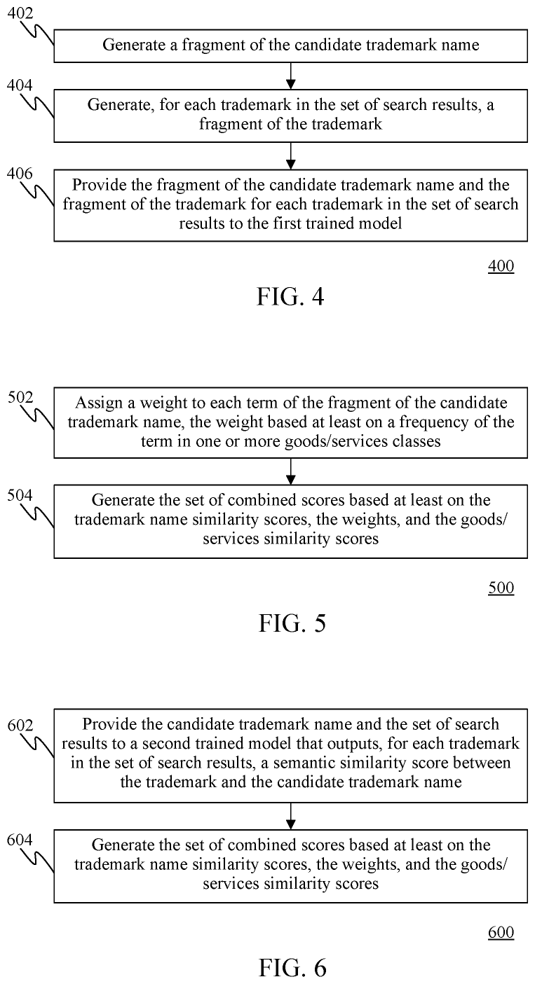

In accordance with one or more embodiments, fragments of a trademark name may be provided to broad learning model 212 and/or strict learning model 214. For example, FIG. 4 shows a flowchart 400 for providing fragments of a candidate trademark name to a trained model in accordance with a further example embodiment. In an embodiment, flowchart 400 is implemented by system 200 as shown in FIG. 2. Accordingly, flowchart 400 will be described with reference to FIG. 2. Other structural and operational embodiments will be apparent to persons skilled in the relevant art(s) based on the following discussion regarding flowchart 400 and system 200 of FIG. 2.

Flowchart 400 begins with step 402. In step 402, a fragment of the candidate trademark name is generated. For example, with reference to FIG. 2, fragment generator 208 may be configured to generate a fragment of the candidate trademark name provided via UI 104. In examples, a fragment of a trademark comprises one or more terms which are the same or similar to the trademark from at least an auditive, visual, or semantic standpoint. For instance, a fragment may comprise a portion (e.g., a subset) of a trademark (e.g., a single word of the trademark or two consecutive words conjoined or adjacent to each other in a forward or reversed order), the trademark (or a subset thereof) with at least one replaced character (e.g., replacing capital letters with lowercase letters, replacing “I” with “!,” etc.), the trademark (or a subset thereof) with a term or terms that have a different interpretation and/or different combination of characters, the trademark (or a subset thereof) with one or more characters or words in a reversed order, etc. In this manner, a different variation may be generated for the candidate trademark based at least on the characters and/or terms contained therein. In some implementations, a plurality of different variations may be generated for the candidate trademark, each of which may be provided as part of a trademark pair to a learning model to generate a similarity score.

In step 404, for each trademark name in the set of search results, a fragment of the trademark name is generated. For example, with reference to FIG. 2, fragment generator 208 may be configured to generate, for each trademark name in the set of search results 204, a fragment of the trademark name. Fragment generator 208 may generate the fragment (or a plurality of fragments) for each trademark name in a similar manner as described above with reference to step 402 (e.g., based on a different variation of the trademark name).

In step 406, the fragment of the candidate trademark name and the fragment of the trademark name for each trademark name in the set of search results are provided to the first trained model. For instance, with reference to FIG. 2, score generator 206 may be configured to provide the generated fragment of the candidate trademark name and the generated fragment of the trademark name for each trademark name in the set of search results 204 to a learning model, such as broad learning model 212 and/or strict learning model 214. For example, broad learning model 212 may be configured output a similarity score for each trademark name in the set of search results 204 based at least on a number of terms in the fragment of the candidate trademark name being deemed similar (e.g., the same or substantially the same) as a number of terms in the fragment of the trademark name (e.g., the trademark name in the set of search results 204 has no additional words compared to the candidate trademark name, or vice versa). In another example, strict learning model 214 may be configured to output a similarity score for each trademark name in the set of search results 204 based at least on a number of terms in the fragment of the candidate trademark name being deemed dissimilar (e.g., different) to a number of terms in the fragment of the trademark name (e.g., the trademark name in the set of search results 204 has one or more additional words compared to the candidate trademark name, or vice versa).

In some implementations, broad learning model 212 and/or strict learning model 214 may generate a score based on how well the candidate trademark name (or fragment generated therefrom) matches the trademark name (or fragment generated therefrom) in the set of search results 204. In another implementation, broad learning model 212 and/or strict learning model 214 may generate a score based on a reversed similarity, i.e., how well the trademark name (or fragment generated therefrom) in the set of search results 204 matches the candidate trademark name (or fragment generated therefrom).

In this manner, broad learning model 212 and/or strict learning model 214 may be used to generate a plurality of different scores, each score based on a different variation of fragments in a pair of trademarks. Such an approach may further enhance the performance of the models, which may improve overall performance of trademark ranking engine 114.

In accordance with one or more embodiments, weights may be assigned to fragments of a trademark name. For example, FIG. 5 shows a flowchart 500 for weighting terms of a fragment of a candidate trademark name in accordance with an example embodiment. In an embodiment, flowchart 500 is implemented by system 200 as shown in FIG. 2. Accordingly, flowchart 500 will be described with reference to FIG. 2. Other structural and operational embodiments will be apparent to persons skilled in the relevant art(s) based on the following discussion regarding flowchart 500 and system 200 of FIG. 2.

Flowchart 500 begins with step 502. In step 502, a weight is assigned to each term of the fragment of the candidate trademark name, where the weight is based at least on a frequency of the term in one or more goods/services classes. For instance, with reference to FIG. 2, importance assigner 210 may be configured to assign a weight 232 from importance weight table 224 to each term of a fragment of a candidate trademark name as generated by fragment generator 208. In examples, the weight assigned to a particular term of the fragment may be based at least on the goods/services information associated with the candidate trademark (e.g., the candidate trademark name). For instance, importance assigner 210 may determine, for each term of the fragment, a frequency of the term in goods/services descriptions of a plurality of goods/services classes (e.g., a class frequency). Importance assigner 210 may then compare each class frequency to a size of each class to normalize the frequency and generate a probability distribution. Based on the probability distribution, a divergence measure is generated that indicates how related a particular term is to descriptions in a goods/services class. Where the divergence is high (e.g., closer to one), the divergence measure indicates that the term is goods/services related. Conversely, where the divergence is low (e.g., closer to zero), the divergence measure indicates that the term is not goods/services related.

Where a term is goods/services related, it is inferred that the term has a reduced uniqueness. In other words, terms that appear more often in goods/services descriptions of a goods/services class may be inferred as being relatively weak terms. Conversely, terms that appear less often in goods/services descriptions of a goods/services class may be inferred as being relatively strong terms. As an illustration, importance assigner may select appropriate weight from importance weight table 224 based its relatedness to a goods/services class (e.g., strong, coupled, weak, or nullified), where a higher weight is assigned to terms that are stronger and a lower weight is assigned to terms that are weaker. While importance weight table 224 identifies a fixed number of weights in an illustration, importance weights need not be selected from a fixed set, but instead may comprise any value on a sliding scale (e.g., from zero to one, or any other range as appropriate). Further, while it is described herein that weights may be assigned to terms of a fragment of a candidate trademark name, weights may also be applied to terms of a fragment of a trademark name in search results 204 in a similar fashion.

In this manner, a weighting value may be assigned to each term that indicates a level of importance of that term in generating a similarity score. For instance, terms like “the” or “ultra” in a trademark name may be identified as weaker terms that are not given as much weight, compared to other coined terms that have no dictionary definition. While techniques disclosed herein describe the assignment of weights based at least on goods/services information, such an approach is not intended to be limiting. Rather, importance values or weights may be assigned to terms of a trademark name (or fragments generated therefrom) in other ways as well.

In step 504, a set of combined scores is generated based at least on the trademark name similarity scores, the weights, and the goods/services similarity scores. For instance, with reference to FIG. 2, score combiner 220 may be configured to generate the set of combined scores based at least on the importance weights assigned to each term of a fragment, the similarity scores generated based on broad learning model 212, strict learning model 214, and/or semantic similarity model 216, and the goods/services similarity score obtained from goods/services scorer 116. In examples, using such weighting enables the combined score to place a heavier weight on terms that are more unique, and less weight on terms that are not unique (e.g., less important), thereby resulting in improved accuracy in ranking search results 204.

In accordance with one or more embodiments, score generator 206 may generate a similarity score based on a semantic similarity between a pair of trademarks. For example, FIG. 6 shows a flowchart 600 for ranking trademark search results based at least in part of a semantic similarity model in accordance with an example embodiment. In an embodiment, flowchart 600 is implemented by system 200 as shown in FIG. 2. Accordingly, flowchart 600 will be described with reference to FIG. 2. Other structural and operational embodiments will be apparent to persons skilled in the relevant art(s) based on the following discussion regarding flowchart 600 and system 200 of FIG. 2.

Flowchart 600 begins with step 602. In step 602, the candidate trademark name and the set of search results are provided to a second trained model that outputs, for each trademark name in the set of search results, a semantic similarity score between the trademark name and the candidate trademark name. For instance, with reference to FIG. 2, score generator 206 may be configured to provide the candidate trademark name and each trademark name in the set of search results 204 to semantic similarity model 216. In an example, semantic similarity model 216 may output, for each trademark name in the set of search results 204, a semantic similarity score between the trademark name and the candidate trademark name. Semantic similarity model 216 may generate a semantic similarity score indicative of a level of similarity (e.g., a distance or closeness) between a meaning of each trademark name in a pair of trademarks. In some implementations, semantic similarity model 216 may generate a vector embedding for each trademark name in a pair of trademarks and generate a similarity score based on a distance between the vector embeddings. In one example implementation, score generator is configured to provide the entire candidate trademark name and each of the trademark names in the set of search results 204 (as opposed to fragments of such trademarks).

In step 604, the set of combined scores is generated based at least on the trademark name similarity scores, the semantic similarity scores, and the goods/services similarity scores. For instance, with reference to FIG. 2, score combiner 220 may be configured to generate the set of combined scores based at least on the trademark name similarity scores (e.g., as generated by broad learning model 212 and/or strict learning model 214), the semantic similarity scores, and the goods/services similarity score obtained from goods/services scorer 116. In examples, using such a combination enables a ranking to be generated based on several different similarity dimensions, which may further result in an improved ranking of search results 204.

### III. Additional Trademark Result Ranking Embodiments

The following sections are intended to further describe the above example embodiments and describe additional example embodiments in which implementations may be provided. Furthermore, the sections that follow explain additional context for such example embodiments and details relating to the implementations. The sections that follow are intended to illustrate various aspects and/or benefits that may be achieved based on techniques described herein, and are not intended to be limiting. Accordingly, while additional example embodiments are described, it is understood that the features described below are not required in all implementations.

In example trademark result ranking embodiments, techniques may be implemented by or in one or more of computing device 102, trademark database 106, computing device 108 (including any components or subcomponents of any of the foregoing), and/or in connection with any steps of flowcharts 300, 400, 500, and/or 600. Other structural and operational implementations will be apparent to persons skilled in the relevant art(s) based on the following discussion.

As described above, trademark ranking engine 114 may operate in various ways to generate a ranked list of search results 204 for a candidate trademark 202. The following paragraphs describe one technique for generating the ranked list of search results. The below paragraphs are provided as an illustration of the techniques disclosed herein, and are not intended to be limiting. Various modifications on the below techniques are contemplated and should be considered to be within the scope of this disclosure.

As described herein, a combined score for a given trademark may be computed in accordance with the following equation:

$$overallScore ( O , T ) = 100 nameScore ( O , T ) ( \frac{9 + productScore ( O , T )}{10} ) ,$$

where overallScore(O, T) represents the combined score (i.e., generated by score combiner 220), nameScore(O, T) represents the trademark name similarity score (e.g., based on a combination of broad learning model 212, strict learning model 214, and/or semantic similarity model 216), and productScore(O, T) represents the goods/services similarity score generated by goods/services scorer 116. In examples, O represents an order (i.e., the candidate trademark), while T represents a trademark from search results 204. Various weights and/or scaling factors may also be applied to such a formula, as shown above. In one example, nameScore(O, T) may be determined as follows:

$$nameScore ( O , T ) = \{ \begin{matrix}{C}_{0.725}^{0.850} & ( seqScore ( O , T ) ) \\ {C}_{0.675}^{0.750} & ( max ( {seqScore ( O , T )}^{3} , semScore ( O , T ) ) )\end{matrix}$$

As shown in the above formula, nameScore(O, T) (e.g., the trademark name similarity score) comprises two components. The first component, seqScore(O, T) is a score representing the visual and/or auditive similarity, which may be generated using broad learning model 212 and/or strict learning model 214 as disclosed herein. The second component, max(seqScore(O, T)³, semScore(O, T)) represents the semantic similarity, which may be generated using semantic similarity model 216. In an example, semScore(O, T) may be calculated by inputting a pair of trademarks comprising the candidate trademark name and each trademark name of search results 204 into semantic similarity model 216. In the above example, semantic similarity is not always used, such as in trademarks where semantics does not play a large role (e.g., in trademarks with coined terms). In other situations, semantics may play a larger role and therefore may be factored into the calculation of the trademark name similarity score.

In an example, the auditive and/or visual similarity score, seqScore(O, T), may be represented as follows:

$$seqScore ( O , T ) = \begin{matrix}max \\ {s}_{o} ∈ seqs ( O ) \\ {s}_{t} ∈ seqs ( T )\end{matrix}$$

$$( ( {W}_{o} ( {t}_{{s}_{o}} ) {W}_{c} ( {t}_{{S}_{t}} ) \begin{matrix}max \\ {f}_{o} ∈ fragments ( {s}_{o} ) \\ {f}_{t} ∈ fragments ( {s}_{t} )\end{matrix} ( max ( {w}_{broad} s i {m}_{broad} ( {f}_{o} , {f}_{t} ) , s i {m}_{strict} ( {f}_{o} , {f}_{t} ) ) ) )$$

In this example, fragments(sₒ) and fragments(sₜ) denote different interpretations of the words of a trademark name (e.g., different subsequences of the words of a trademark name, words in a different order, concatenated words, etc.). In this example, each of those fragments may be applied to the broad learning model 212 corresponding to the sim_{broad} notation and the strict learning model corresponding to the sim strict notation. In one example, both learning models (e.g., neural networks) are used to generate a combined score as described herein. In an example, w_{broad} may designate a weight for the broad learning model. Furthermore, Wₒ(t) and Wₜ(t) may designate respective weights regarding whether the trademark is a primary name or a secondary name. A primary name may comprise the trademark as inputted or located in a search result (e.g., without any variation of the characters and/or terms therein), and may therefore be given one weight (e.g., a higher weight of 1.0, in an example). A secondary interpretation may comprise a trademark with one or more variations as generated herein, and may be assigned a different weight (e.g., a lower weight, such as 0.95, in an example).

In examples, sim_{broad}(fₒ, fₜ) and sim_{strict}(fₒ, fₜ) may be denoted as follows:

sim_{broad}(fₒ,fₜ)=w_{ord}scoreprofile_{broad}(fₒ,fₜ,s_{f}_{ₒ})W(s_{f}_{ₒ})+(1−w_{ord})scoreprofile_{broad}(fₒ,fₜ,s_{f}_{ₜ})W(s_{f}_{ₜ})

sim_{strict}(fₒ,fₜ)=w_{ord}scoreprofile_{strict}(fₒ,fₜ,s_{f}_{ₒ})W(s_{f}_{ₒ})+(1−w_{ord})scoreprofile_{strict}(fₒ,fₜ,s_{f}_{ₜ})W(s_{f}_{ₜ})

In this example, sim_{broad}(fₒ, fₜ) and sim_{strict}(fₒ, fₜ) may represent scores generated based on neural networks (e.g., scoreprofile_{broad} and scoreprofile_{strict}) that are trained based at least on historical data, where the broad model is trained using instances where an analyst applied a broad selection and the strict model is trained using instances where an analyst applied a strict (e.g., narrow or restrictive) selection in determining whether a pair of trademarks is similar. As shown in the above, w_{ord} may designate another weighting factor. In this example, the auditive and/or visual similarity score may be generated from different angles. In the first angle, the similarity score is generated by taking the candidate trademark name as the starting point (e.g., by determining how well a trademark name of search results 204 matches the candidate trademark name). In the second angle, the similarity score is generated by taking a trademark name of search results 204 as the starting point.

In an example, scoreprofile_{broad} (fₒ, fₜ, s_{f}_{ₒ}) may be denoted as follows:

$${scoreprofile}_{broad} ( {f}_{o} , {f}_{t} , {s}_{{f}_{o}} ) = [ \begin{matrix}{v}_{1} \\ {v}_{2} \\ ⋮ \\ {v}_{\vert {s}_{{f}_{o}} \vert}\end{matrix} ] , \\ with {v}_{i} = \{ \begin{matrix}{score}_{broad} ( {f}_{o} , {f}_{t} ) & {w}_{i} ∈ {f}_{o} \\ 0 & {w}_{i} ∉ {f}_{o}\end{matrix}$$

In the above examples, two fragments are compared with each other by taking the word couples (one word from a first fragment and one word from a second fragment), and comparing the word couples using a trained neural network (e.g., broad learning model 212), resulting in a word-word score. Based on the word-word scores, the highest scoring word couples may be selected based on pre-defined thresholds or cutoffs and/or overlap rules. A weighted sum may then be applied to the selected word couples, where the weights are determined by an importance of words in a trademark (e.g., as described herein with respect to importance assigner 210). For instance, the importance of words may be calculated by measuring a frequency of a word in a goods/services description of the trademarks in a trademark corpus, and measuring a frequency of a word in the trademark name of the trademark corpus.

As noted earlier, these examples are not intended to be limiting, and are intended to illustrate an example operation of various aspects described herein. Various modifications may be made without departing from the scope of the disclosed embodiments (e.g., modification of the formulas described, selection of different weights, etc.).

### IV. Example Mobile Device and Computer System Implementation

Each of computing device 102, user interface 104, trademark database 106, computing device 108, trademark scoring system 110, search engine 112, trademark ranking engine 114, goods/services scorer 116, score generator 206, fragment generator 208, importance assigner 210, broad learning model 212, strict learning model 214, semantic similarity model 216, score combiner 220, ranker 222, and/or any of the steps of flowcharts 300, 400, 500, and/or 600 may be implemented in hardware, or hardware combined with software and/or firmware. For example, computing device 102, user interface 104, trademark database 106, computing device 108, trademark scoring system 110, search engine 112, trademark ranking engine 114, goods/services scorer 116, score generator 206, fragment generator 208, importance assigner 210, broad learning model 212, strict learning model 214, semantic similarity model 216, score combiner 220, ranker 222, and/or any of the steps of flowcharts 300, 400, 500, and/or 600 may be implemented as computer program code (e.g., instructions in a programming language) configured to be executed in one or more processors and stored in a computer readable storage medium. Alternatively, computing device 102, user interface 104, trademark database 106, computing device 108, trademark scoring system 110, search engine 112, trademark ranking engine 114, goods/services scorer 116, score generator 206, fragment generator 208, importance assigner 210, broad learning model 212, strict learning model 214, semantic similarity model 216, score combiner 220, ranker 222, and/or any of the steps of flowcharts 300, 400, 500, and/or 600 may be implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702, a network-based server infrastructure 770, and an on-premises servers 792. As shown in FIG. 7, computing device 702, network-based server infrastructure 770, and on-premises storage 792 are communicatively coupled via network 704. Network 704 comprises one or more networks such as local area networks (LANs), wide area networks (WANs), enterprise networks, the Internet, etc., and may include one or more wired and/or wireless portions. Network 704 may additional or alternatively include a cellular network for cellular communications.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein. Computing device 702, network-based server infrastructure 770, and on-premises storage 792 are described in detail as follows.

Computing device 702 can be any of a variety of types of computing devices. For example, computing device 702 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further busses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a hard disk (e.g., a magnetic disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a solid-state drive (SSD), a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing one or more of computing device 102, user interface 104, trademark database 106, computing device 108, trademark scoring system 110, search engine 112, trademark ranking engine 114, goods/services scorer 116, score generator 206, fragment generator 208, importance assigner 210, broad learning model 212, strict learning model 214, semantic similarity model 216, score combiner 220, ranker 222, along with any components and/or subcomponents thereof, as well as the flowcharts/flow diagrams (e.g., flowcharts 300, 400, 500, and/or 600) described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi 762 modem (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present. Server infrastructure 770 may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, nodes 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 772 may be a datacenter in a distributed collection of datacenters. In embodiments, exemplary computing environment 700 comprises part of a cloud-based platform such as Amazon Web Services® of Amazon Web Services, Inc. or Google Cloud Platform™ of Google LLC, although these are only examples and are not intended to be limiting.

In an embodiment, computing device 702 may access application programs 776 for execution in any manner, such as by a client application and/or a browser at computing device 702. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 720 at network-based server infrastructure 770.

In some embodiments, on-premises servers 792 may be present. On-premises servers 792 are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

As used herein, the terms “computer program medium,” “computer-readable medium,” and “computer-readable storage medium,” etc., are used to refer to physical hardware media. Examples of such physical hardware media include any hard disk, magnetic disk, optical disk, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the claimed embodiments should not be limited by any of the above-described exemplary embodiments, but should be defined only in accordance with the following claims and their equivalents.

What is claimed is:

1. A method for ranking trademark search results, comprising:
receiving information about a candidate trademark, the information including at least a candidate trademark name and goods/services information;
obtaining a set of search results comprising trademark names having at least a minimum degree of similarity with the candidate trademark name;
providing the candidate trademark name and the set of search results to a first trained model, the first trained model outputs, for each trademark name in the set of search results, a trademark name similarity score between the trademark name and the candidate trademark name, the first trained model is trained based at least on pairs of historical trademark names marked as either similar or dissimilar;
for each trademark name in the set of search results, obtaining a goods/services similarity score indicating a level of similarity between goods/services information associated with the trademark name and goods/services information associated with the candidate trademark name;
generating a set of combined scores based at least on the trademark name similarity scores and the goods/services similarity scores; and
providing a ranked list of the search results based at least on the set of combined scores.

2. The method of claim 1, wherein the trademark name similarity score for each trademark name in the set of search results indicates a level of visual similarity between the trademark name and the candidate trademark name.

3. The method of claim 1, wherein the trademark name similarity score for each trademark name in the set of search results indicates a level of auditive similarity between the trademark name and the candidate trademark name.

4. The method of claim 1, further comprising:
generating a fragment of the candidate trademark name;
generating, for each trademark name in the set of search results, a fragment of the trademark name; and
providing the fragment of the candidate trademark name and the fragment of the trademark name for each trademark name in the set of search results to the first trained model.

5. The method of claim 4, wherein the first trained model outputs the trademark name similarity score for each trademark name in the set of search results based at least on a number of terms in the fragment of the candidate trademark name being deemed similar to a number of terms in the fragment of the trademark name.

6. The method of claim 4, wherein the first trained model outputs the trademark name similarity score for each trademark name in the set of search results based at least on a number of terms in the fragment of the candidate trademark name being deemed dissimilar to a number of terms in the fragment of the trademark name.

7. The method of claim 4, further comprising:
assigning a weight to each term of the fragment of the candidate trademark name, the weight based at least on a frequency of the term in one or more goods/services classes, and
wherein the set of combined scores is generated based at least on the trademark name similarity scores, the weights, and the goods/services similarity scores.

8. The method of claim 1, further comprising:
providing the candidate trademark name and the set of search results to a second trained model that outputs, for each trademark name in the set of search results, a semantic similarity score between the trademark name and the candidate trademark name, and
wherein the set of combined scores is generated based at least on the trademark name similarity scores, the semantic similarity scores, and the goods/services similarity scores.

9. A system for ranking trademark search results, comprising:
at least one processor circuit; and
at least one memory that stores program code configured to be executed by the at least one processor circuit, the program code is configured to, when executed by the at least one processor circuit, cause the system to:
receive information about a candidate trademark, the information including at least a candidate trademark name and goods/services information;
obtain a set of search results comprising trademark names having at least a minimum degree of similarity with the candidate trademark name;
provide the candidate trademark name and the set of search results to a first trained model, the first trained model outputs, for each trademark name in the set of search results, a trademark name similarity score between the trademark name and the candidate trademark name, the first trained model is trained based at least on pairs of historical trademark names marked as either similar or dissimilar;
for each trademark name in the set of search results, obtain a goods/services similarity score indicating a level of similarity between goods/services information associated with the trademark name and goods/services information associated with the candidate trademark name;
generate a set of combined scores based at least on the trademark name similarity scores and the goods/services similarity scores; and
provide a ranked list of the search results based at least on the set of combined scores.

10. The system of claim 9, wherein the trademark name similarity score for each trademark name in the set of search results indicates a level of visual similarity between the trademark name and the candidate trademark name.

11. The system of claim 9, wherein the trademark name similarity score for each trademark name in the set of search results indicates a level of auditive similarity between the trademark name and the candidate trademark name.

12. The system of claim 9, wherein the program code is further configured to, when executed by the at least one processor circuit, cause the system to:
generate a fragment of the candidate trademark name;
generate, for each trademark name in the set of search results, a fragment of the trademark name; and
provide the fragment of the candidate trademark name and the fragment of the trademark name for each trademark name in the set of search results to the first trained model.

13. The system of claim 12, wherein the first trained model outputs the trademark name similarity score for each trademark name in the set of search results based at least on a number of terms in the fragment of the candidate trademark name being deemed similar as a number of terms in the fragment of the trademark name.

14. The system of claim 12, wherein the first trained model outputs the trademark name similarity score for each trademark name in the set of search results based at least on a number of terms in the fragment of the candidate trademark name being deemed dissimilar to a number of terms in the fragment of the trademark name.

15. The system of claim 12, wherein the program code is further configured to, when executed by the at least one processor circuit, cause the system to:
assign a weight to each term of the fragment of the candidate trademark name, the weight based at least on a frequency of the term in one or more goods/services classes, and
wherein the set of combined scores is generated based at least on the trademark name similarity scores, the weights, and the goods/services similarity scores.

16. The system of claim 9, wherein the program code is further configured to, when executed by the at least one processor circuit, cause the system to:
provide the candidate trademark name and the set of search results to a second trained model that outputs, for each trademark name in the set of search results, a semantic similarity score between the trademark name and the candidate trademark name, and
wherein the set of combined scores is generated based at least on the trademark name similarity scores, the semantic similarity scores, and the goods/services similarity scores.

17. A computer-readable storage medium having program instructions recorded thereon that, when executed by at least one processor, perform a method comprising:
receiving information about a candidate trademark, the information including at least a candidate trademark name and goods/services information;
obtaining a set of search results comprising trademark names having at least a minimum degree of similarity with the candidate trademark name;
providing the candidate trademark name and the set of search results to a first trained model, the first trained model outputs, for each trademark name in the set of search results, a trademark name similarity score between the trademark name and the candidate trademark name, the first trained model is trained based at least on pairs of historical trademark names marked as either similar or dissimilar;
for each trademark name in the set of search results, obtaining a goods/services similarity score indicating a level of similarity between goods/services information associated with the trademark name and goods/services information associated with the candidate trademark name;
generating a set of combined scores based at least on the trademark name similarity scores and the goods/services similarity scores; and
providing a ranked list of the search results based at least on the set of combined scores.

18. The computer-readable medium of claim 17, wherein the trademark name similarity score for each trademark name in the set of search results indicates one of a level of visual similarity or a level of auditive similarity between the trademark name and the candidate trademark name.

19. The computer-readable medium of claim 17, wherein the method further comprises:
generating a fragment of the candidate trademark name;
generating, for each trademark name in the set of search results, a fragment of the trademark name; and
providing the fragment of the candidate trademark name and the fragment of the trademark name for each trademark name in the set of search results to the first trained model.

20. The computer-readable medium of claim 17, wherein the method further comprises:
providing the candidate trademark name and the set of search results to a second trained model that outputs, for each trademark name in the set of search results, a semantic similarity score between the trademark name and the candidate trademark name, and
wherein the set of combined scores is generated based at least on the trademark name similarity scores, the semantic similarity scores, and the goods/services similarity scores.
